(19) United States
(12) Patent Application Publication
(10) Pub. No.: US 2009/0055503 A1
(43) Pub. Date: Feb. 26, 2009

(54) Method and System for Providing, Tracking and Monitoring Express Notifications

(75) Inventors: Arthur R. Crivella, Pittsburgh, PA (US); Wayne J. West, Henderson, NV (US)

Correspondence Address: PEPPER HAMILTON LLP, ONE MELLON CENTER, 50TH FLOOR, 500 GRANT STREET, PITTSBURGH, PA, 15219, US

(73) Assignee: ASE EDGE, INC., Carnegie, PA (US)

(21) Appl. No.: 12/131,632

(22) Filed: Jun. 2, 2008

Related U.S. Application Data
(60) Provisional application No. 60/941,232, filed on May 31, 2007.

(51) Int. Cl. G06F 15/16; G06Q 99/00

(52) U.S. Cl. 709/207; 705/7

(57) ABSTRACT

A method of tracking electronic communications may include generating a notification in response to receiving information associated with an insurance claim. The content of the notification may be defined by one or more first business rules. The method may include receiving an identifier associated with the received notification, generating an electronic message comprising the notification and the identifier and sending the electronic message to one or more recipients. The one or more recipients may be defined by one or more second business rules.

### CROSS REFERENCE TO RELATED APPLICATIONS

This application claims priority under 35 U.S.C. § 119(e) to U.S. Provisional Application No. 60/941,232, filed May 31, 2007, the entirety of which is incorporated by reference herein.

Not Applicable

### BACKGROUND

Communications in business settings, such as notifications, documents, emails, hyperlinks and the like, are often electronically transmitted to one or more recipients. Once the communication has been transmitted, however, it is often difficult for a sender, such as an individual, an entity, an organization or the like, to track the communication, monitor delivery status and access other similar information related to the transmitted communication and its content. As such, methods and systems for tracking electronically transmitted communications and for providing a sender with information regarding the communication after it has been transmitted would be desirable.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a method of tracking electronic communications may include generating a notification in response to receiving information associated with an insurance claim. The content of the notification may be defined by one or more first business rules. The method may include receiving an identifier associated with the received notification, generating an electronic message comprising the notification and the identifier and sending the electronic message to one or more recipients. The one or more recipients may be defined by one or more second business rules.

In an embodiment, a method of tracking electronic communications may include generating a notification in response to receiving information associated with a litigation matter. The content of the notification may be defined by one or more first business rules. The method may include receiving an identifier associated with the received notification, generating an electronic message comprising the notification and the identifier and sending the electronic message to one or more recipients. The one or more recipients may defined by one or more second business rules.

In an embodiment, a method of tracking vendor compliance may include receiving a vendor contract from a user, receiving, from the user, information relating to one or more insurance requirements associated with the vendor contract, automatically requesting a certificate associated with the vendor contract, receiving the certificate, automatically analyzing the certificate for compliance and displaying an indication of one of compliance and non-compliance.

In an embodiment, a method of tracking vendor compliance may include receiving a vendor contract from a user, receiving, from the user, information relating to one or more insurance requirements associated with the vendor contract, automatically requesting a certificate associated with the vendor contract, determining whether the requested certificate has been received and sending a notification to a vendor associated with the vendor contract.

### BRIEF DESCRIPTION OF THE DRAWINGS

FIGS. 1.1-2.9 depict exemplary screen shots of a mass tort carrier notification system according to an embodiment.

FIG. 3A depicts an exemplary flow diagram for providing express notice according to an embodiment.

FIG. 3B depicts an exemplary process collaboration diagram according to an embodiment.

FIG. 4 depicts exemplary notification statuses for a set of contracts according to an embodiment.

FIG. 5 depicts an exemplary notification that may be sent to a recipient according to an embodiment.

FIG. 6 depicts an exemplary flow chart of tracking vendor compliance using an automated certificate tracking system according to an embodiment.

FIG. 7 depicts an exemplary interface with which the user may view its notifications according to an embodiment.

FIG. 8 depicts an exemplary notification according to an embodiment.

FIG. 9 depicts an exemplary form according to an embodiment.

FIG. 10 depicts an exemplary notification history according to an embodiment.

### DETAILED DESCRIPTION

Communications, such as notifications, documents, emails, hyperlinks and the like, are often electronically transmitted to one or more recipients. In an embodiment, a communication may include one or more notifications that may be sent to one or more recipients. A notification may be electronically generated and may include an email, a text message, a Short Message Service (SMS) text message, a Multimedia Message Service (MMS) text message or the like. In an embodiment, a notification may include a rule based notification generated from one or more rules supplied by a user. Notifications may provide a recipient with notice of an insurance liability claim, notice of a legal claim, notice of deficiencies in an application or the like. Generating and sending notifications is a common occurrence in business verticals such as litigation claims management, certificate and insurance risk management industries and other industries that are sensitive to notifying people in a timely fashion.

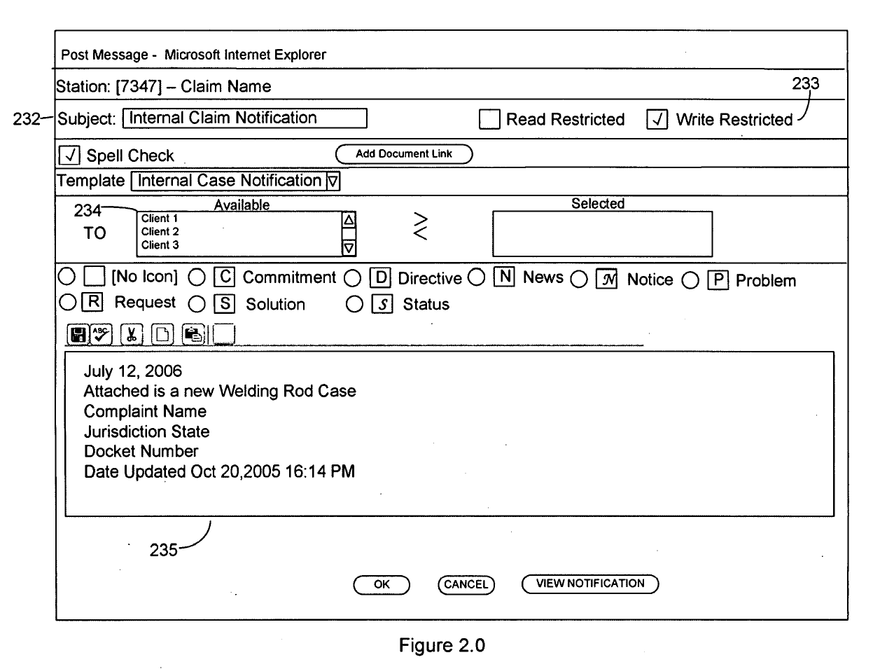

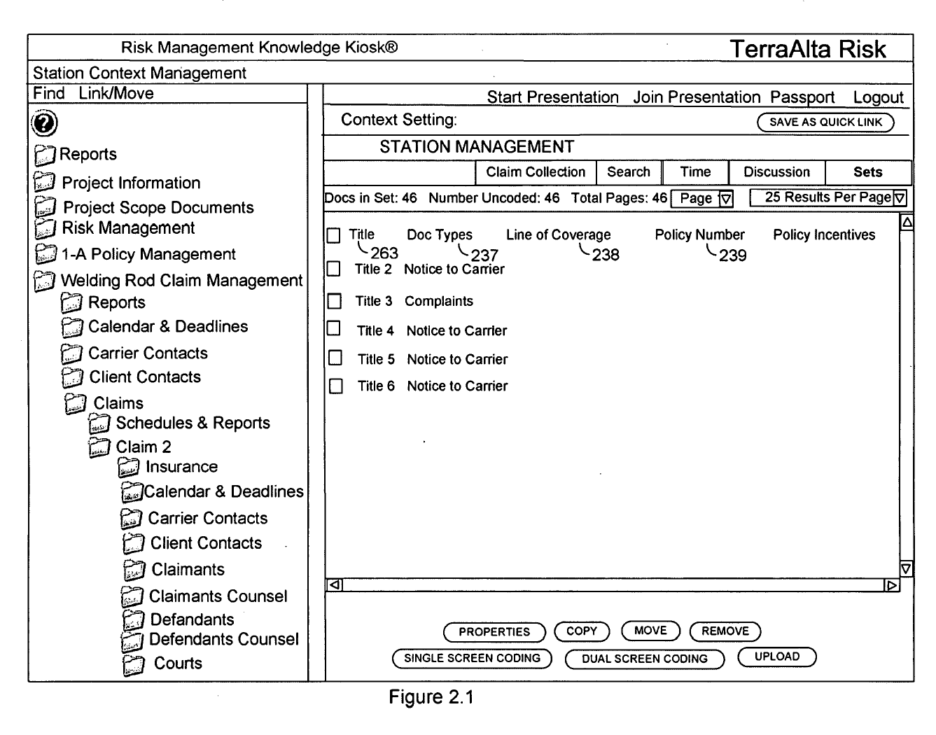

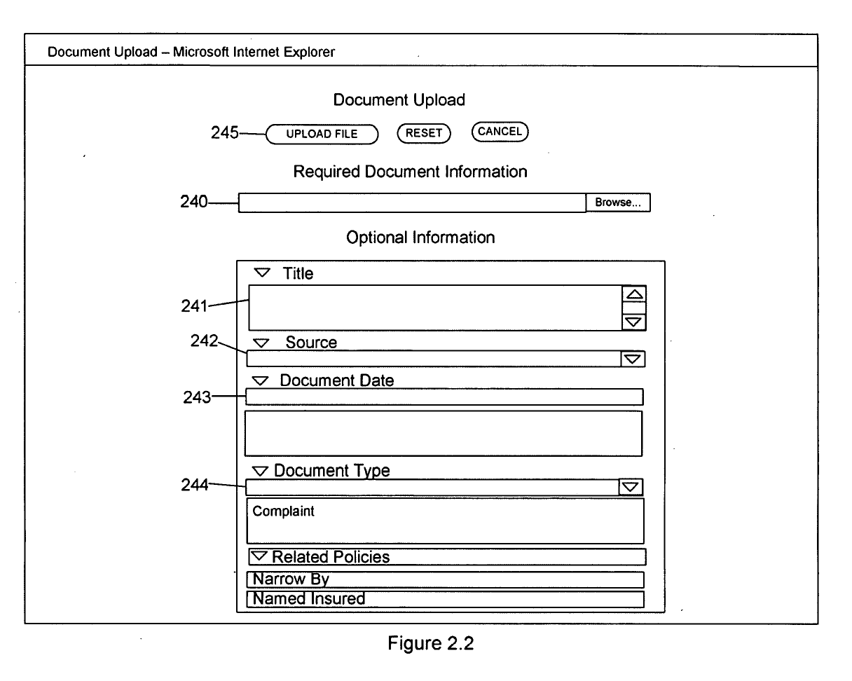

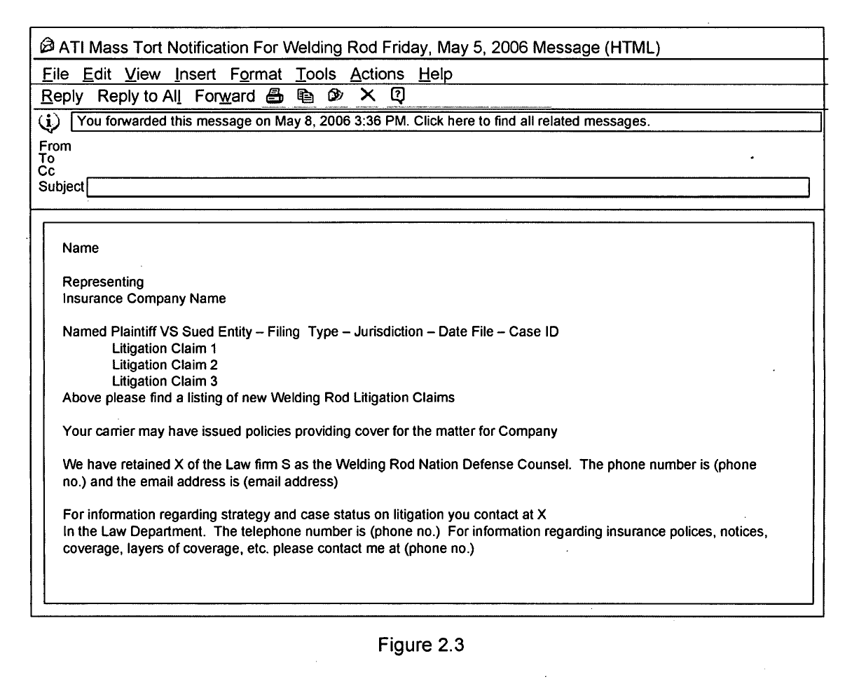

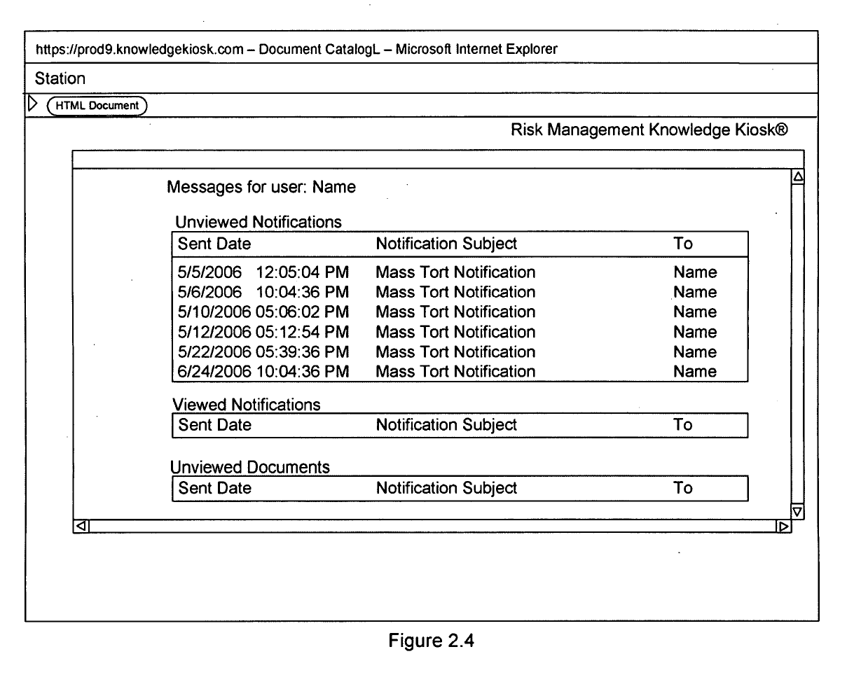

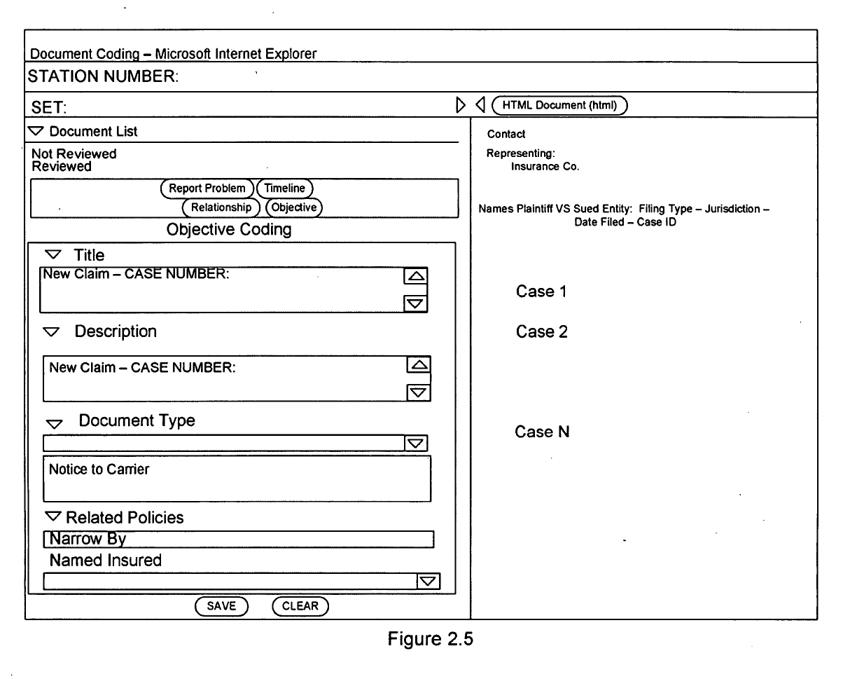

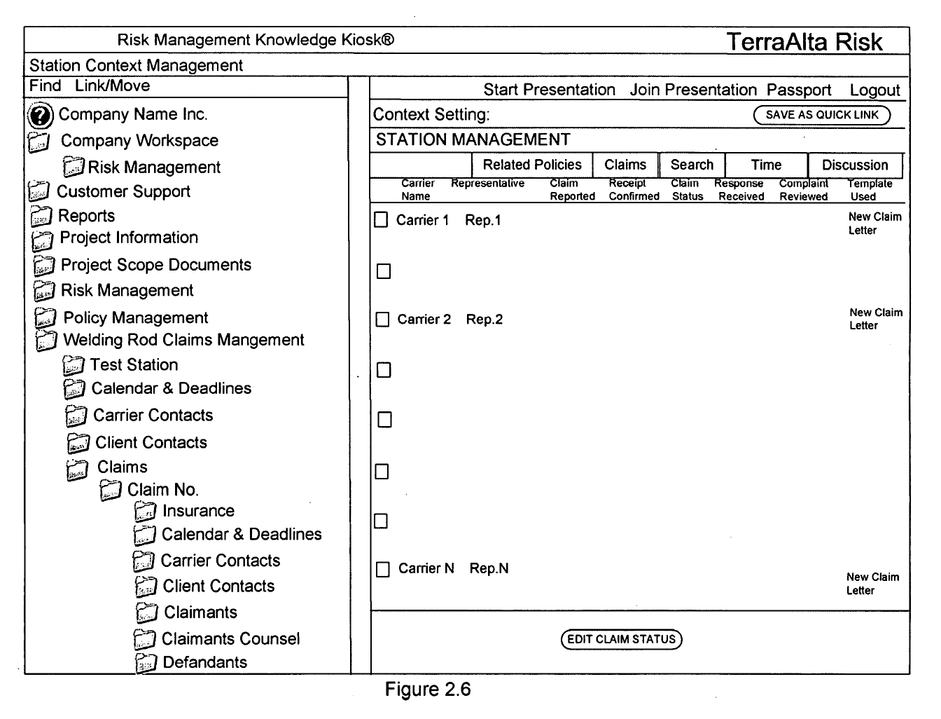

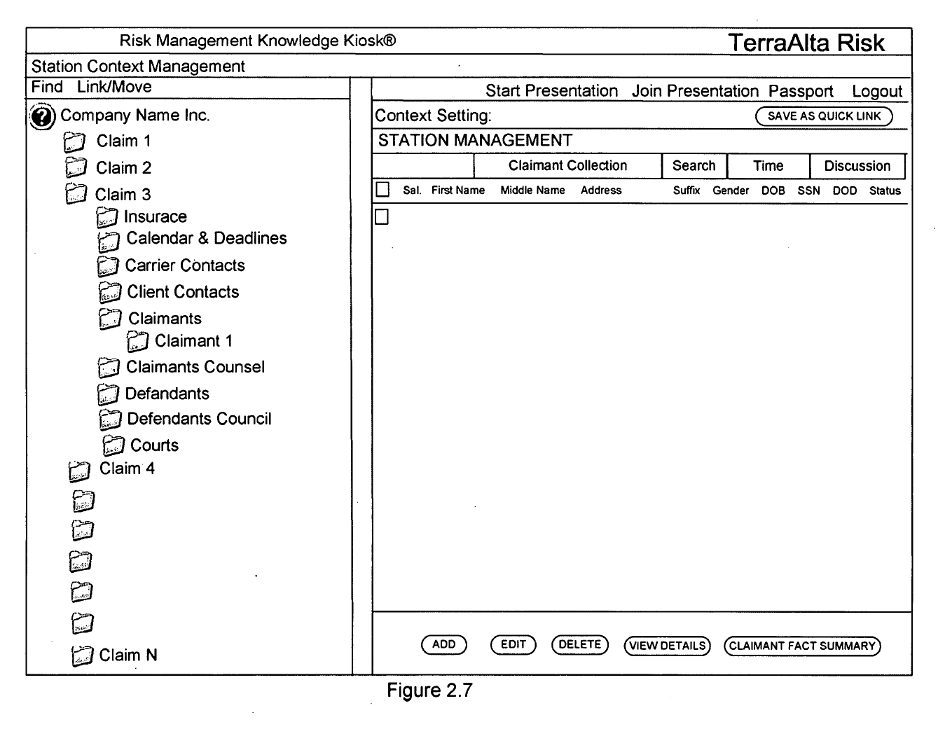

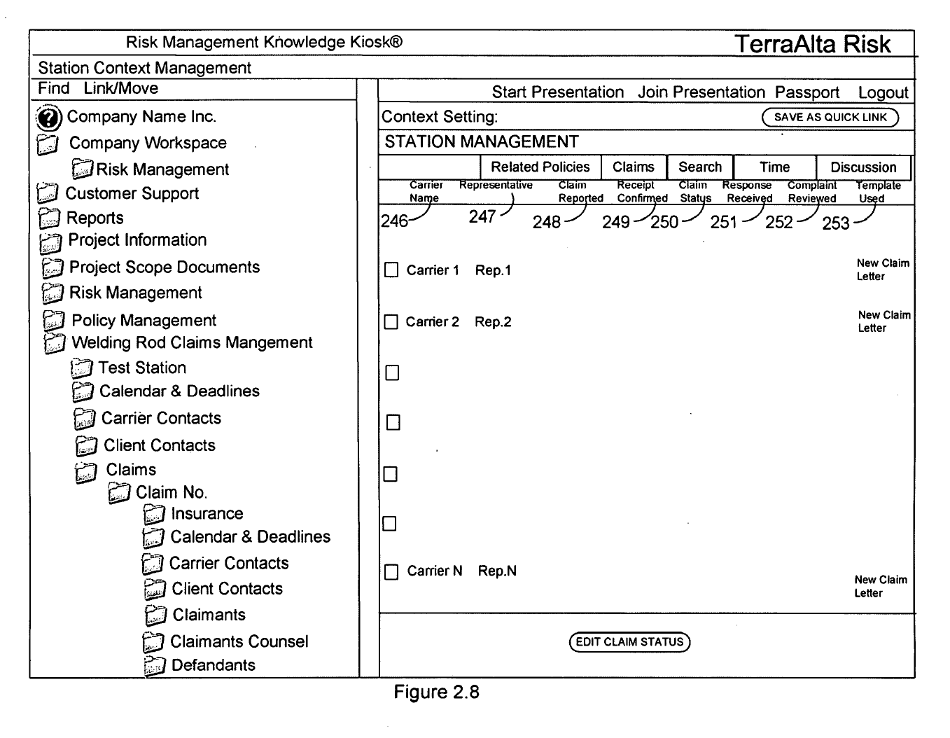

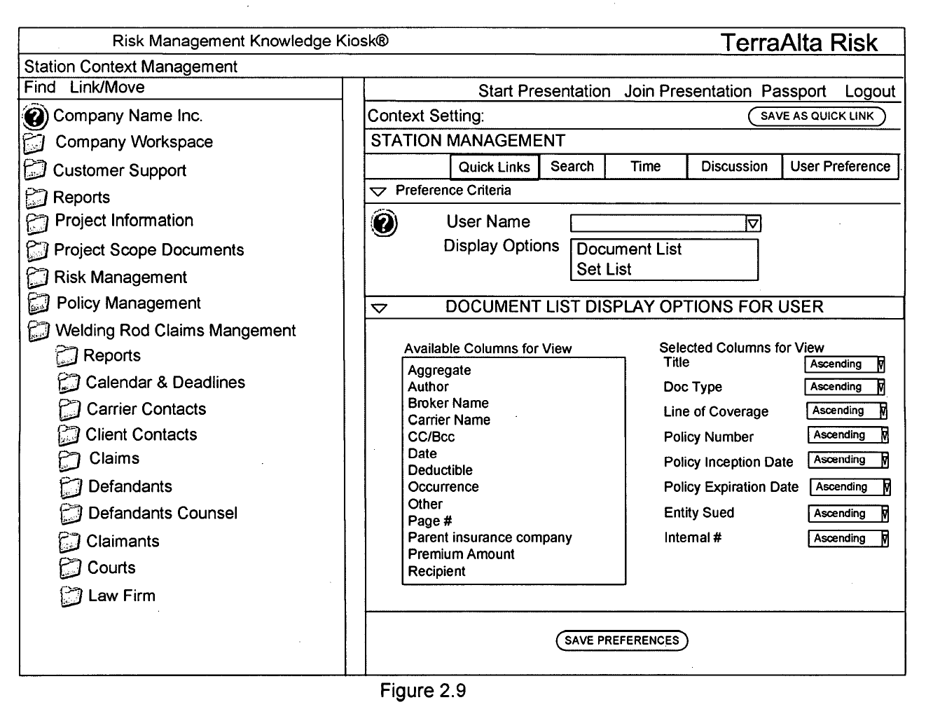

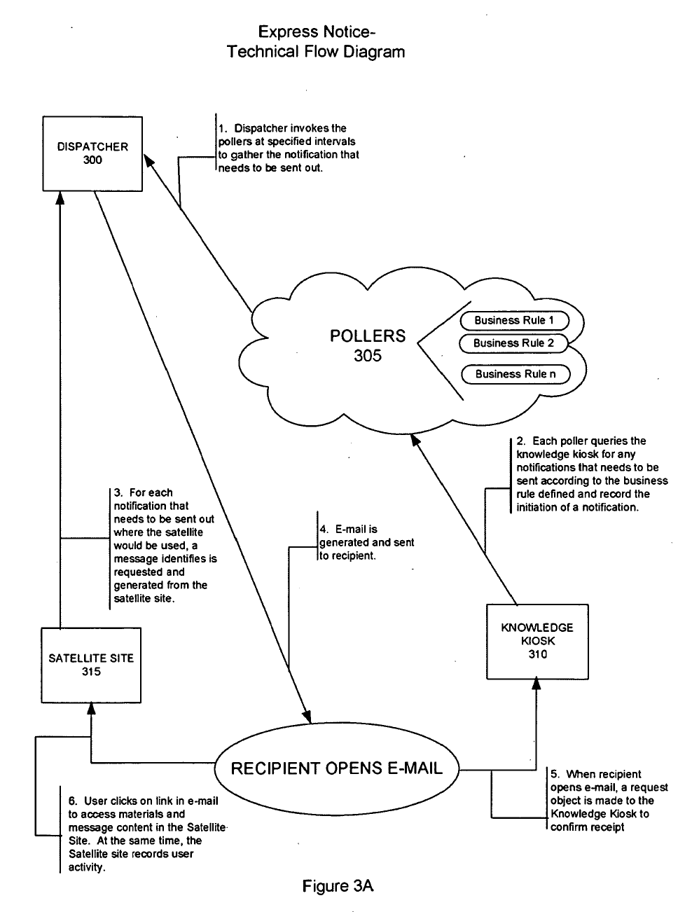

FIG. 3A illustrates an exemplary system for providing express notification to a recipient. FIG. 3B illustrates an exemplary method of providing express notification to a recipient using the system illustrated in FIG. 3A.

In an embodiment, a dispatcher 300 may invoke 320 one or more pollers 305 at specified intervals to gather notifications to be sent. A dispatcher 300 may include a service for broadcasting a notification to one or more recipients or the like. A poller 305 may include one or more business rules that define the content of the notification to be sent or the like. Each poller 305 may query 325 a knowledge kiosk 310 for notifications to be sent. A knowledge kiosk 310 may include a web browsing tool for accessing a website or other user interface with which clients may initiate business processes and track and/or manage their notifications.

In an embodiment, a knowledge kiosk 310 may return 330 one or more notifications to a poller 305. The poller 305 may create one or more notification objects associated with the returned notifications and may record 335 the objects on the knowledge kiosk 310. In an embodiment, the poller 305 may send 340 one or more notification objects to the dispatcher 300. The dispatcher 300 may request 345 one or more message identifiers from a satellite site 315. A message identifier may correspond to each received notification. A satellite site 315 may include a website or other user interface that acts as a repository for notifications and other related materials intended for a recipient. In an embodiment, the satellite site 315 may send 350 the dispatcher 300 one or more message identifiers.

The dispatcher 300 may generate 355 an electronic notification and may send the electronic notification to one or more recipients. In an embodiment, an electronic notification may be an email, a text message and/or the like. In an embodiment, the dispatcher 300 may record 360 a time, date and/or the like when the electronic message is sent. In an embodiment, when a recipient opens the email, a confirmation confirming receipt of the email by the recipient may be generated 365 by the knowledge kiosk 310. In an embodiment, the email may include navigation elements, such as a hyperlink, that may be linked to content stored in the system. When a user selects a navigation element from the email, the user may access materials and message content from the satellite site, while the satellite site may record 370 and track the user's activity.

An express notice system may track, report and automate business process communications which may in turn create a concise record of both communications and minimize liability. The system may use electronic communication as a basis for opening up a business-responsive communication channel between different parties utilizing the above components.

The system may maintain a complete audit trail of all electronic communication, including status updates and other vital information. It may also reduce cycle time and avoid costs associated with sending notices manually. The recipients of the notification may be provided with their own secure site for storing and reviewing information and materials relating to different matters, such as trial materials, case updates, contract compliance (insurance-risk management), legal e-discovery (litigation hold), reports and the like.

Track email/notification may include the following information: (i) message delivery statuses; (ii) time of delivery; (iii) message content; (iv) receipt confirmation from user; and (v) user activity relating to the message content, tracked on the satellite web site.

Reporting can span all aspects of this product, providing users or clients with a robust picture with respect to email/notification process flow and actions performed by the recipients. The system may enable clients to meet their notice obligations as defined per the business settings and/or rules quickly and efficiently by producing a completely verifiable record of every notice sent including records of receipt confirmations.

The system may enable additional business rules defined by the clients to be added. The incorporation of such business rules may enable clients to automate and/or streamline their notification process. The system not only removes manual intervention, but also provides a framework that can quickly accommodate different business processes.

By creating a structured communication with a reliable tracking and reporting mechanism, liabilities may be minimized especially in business verticals such as litigation claims management and certificate/insurance risk management, which are sensitive to notifying people in a timely fashion.

The system may include the following: (i) a dispatcher service broadcasting notifications to recipients; (ii) a poller that includes a set of business rules that define the message content to be sent out; (iii) a satellite website that acts as a repository for messages and other related materials intended for the recipients; and (iv) a knowledge kiosk where clients can initiate their business processes and track/manage their notifications.

In an embodiment, the system may be used to provide liability claims notification. The system may create a complete audit trail of all claim communications, including status updates trial information and the like. The system may track the date and time of origination and receipt of every claim communication. The system may support notices for numerous claim types or litigation matters, including mass tort, multi-district matters and the like.

TABLE 1

| Features and Benefits | What this means to customers |
|---|---|
| Automated claims | May manage all types of liability claims |
| notification process | notification on one on-line solution |
| | May generate timely reports of new liability |
| | claims |
| | May auto-generate initial claims notices to all |
| | relevant claims adjusters |
| | May significantly reduce notification costs and |
| | increase productivity |
| | May ensure proof of receipt and review of |
| | claims through automated notice confirmation |
| | and receipt of exception reports |
| | May provide a real time audit trail of all claim |
| | notification activities and correspondence |
| Tools to maximize | May expedite claim recovery by providing |
| claim recovery | each adjuster with their own on-line repository |
| | for all notifications |
| | May reply quickly to adjusters' claim inquiries |
| | by linking claims to relevant policies in the |
| | policy archive |
| | May create recovery advantage with on-line |
| | access to claims information through standard |
| | and ad hoc reporting |

In an embodiment, a mass tort carrier notification (“MTCN”) system may provide clients with an automated, end-to-end solution that may provide timely notification of new claims, status updates and trial reporting to insurers' claims adjusters.

Companies facing mass tort litigation have significant challenges in meeting the demands and expense this type of litigation imposes. The increased workload on finite legal and risk management resources compromises their ability to effectively meet other day-to-day business responsibilities, which can negatively affect a company's profits.

The cost of litigation is often covered in whole or in part by a company's insurance policies. However, in order to recover their legal costs, the company must comply with certain obligations in making claims on their insurance carriers. The most stringent of these obligations arise from the insurance companies' right to know that a claim is pending before a “case” comes to trial. Carriers also have the right to demand regular updates on case status throughout the process. Finally, mass torts exposure periods can span long periods of time and many primary and excess carriers may need to be notified of every claim that is received.

A mass tort carrier notification system may be designed to provide clients' risk managers and their legal departments with an automated, end-to-end solution that ensures timely notification of new claims, status updates and trial reporting to insurers' claims adjusters. This solution may also provide risk managers and their legal departments with a complete audit trail of carrier notifications for claims and trial reporting.

The disclosed example is a reliable, easy to use mass tort carrier notification system that may help corporate clients meet their obligations to notify their insurance companies' claims adjusters of litigation claims related to mass tort litigation. The system design may enable corporations to meet their notice of claim obligations quickly and efficiently, with a completely verifiable record of every claim notice sent, including records of receipt confirmations.

This notification functionality is further designed to reduce cycle time, and to avoid costs associated with sending notices manually or paying high fees associated with having insurance brokers manage the process. The carriers, who are an integral collaboration partner in this notification process may be provided with their own secure satellite web-site for storing and reviewing claim information and receiving trial material, case updates and reports.

In an embodiment, a risk manager may make timely carrier notifications and track the carrier claim review process. A legal department may add new claims or edit claims when status changes occur, record trial notes and transcripts for notification and notify risk management that a new claim has been added or that a claim status has changed. In an embodiment, an end-to-end legal management solution capable of supporting the entire mass tort legal defense process may be integrated with the carrier notification system.

In an embodiment, a risk administrator may manage users and provide training to new users as they are added to the system. Risk customer support personnel may utilize the site to resolve client issues as they arise. In an embodiment, carrier notification contacts may utilize the mass tort notification satellite system to view claims notices, retrieve complaints, updates and trial notices for their claims processing work.

According to various embodiments, selection elements may include any combination of drop-down menus, radio buttons, text entry, and the like. Although specific types of selection elements and specific numbers of selection elements are described in various embodiments, it is understood that more, fewer, alternate and/or additional selection elements may also be used.

Although specific selection methods, such as clicking a selection, right-clicking a selection, pressing a button and the like, are described in various embodiments, it is understood that more, fewer, alternate and/or additional selection methodologies may also be used.

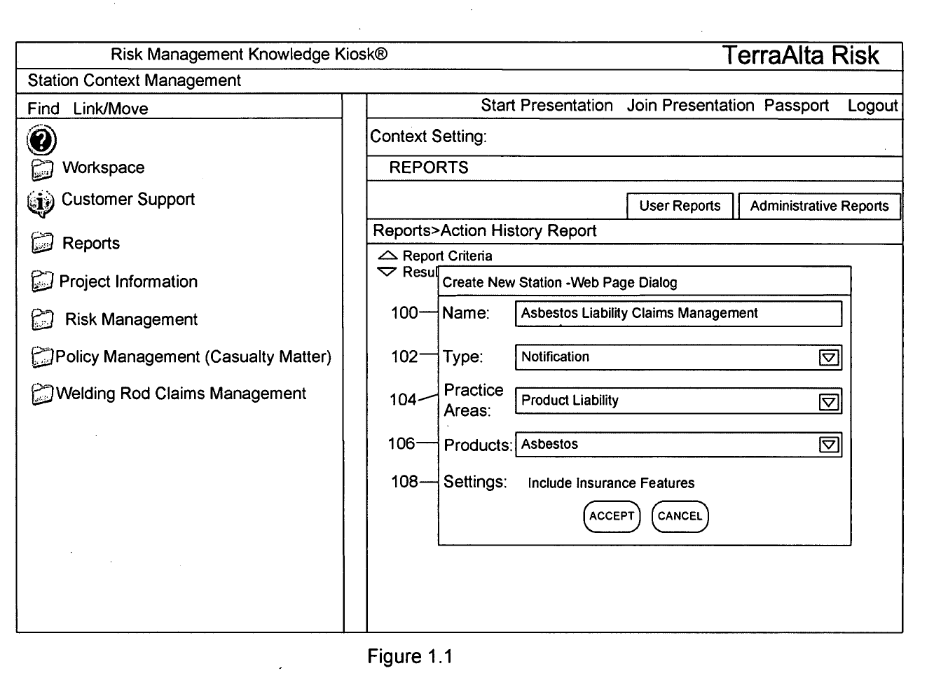

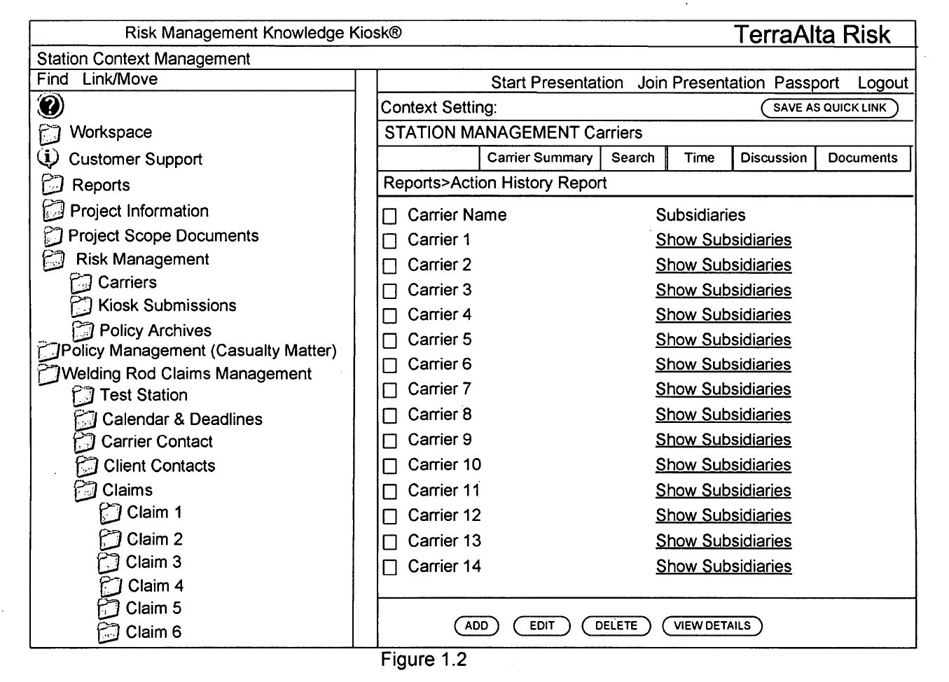

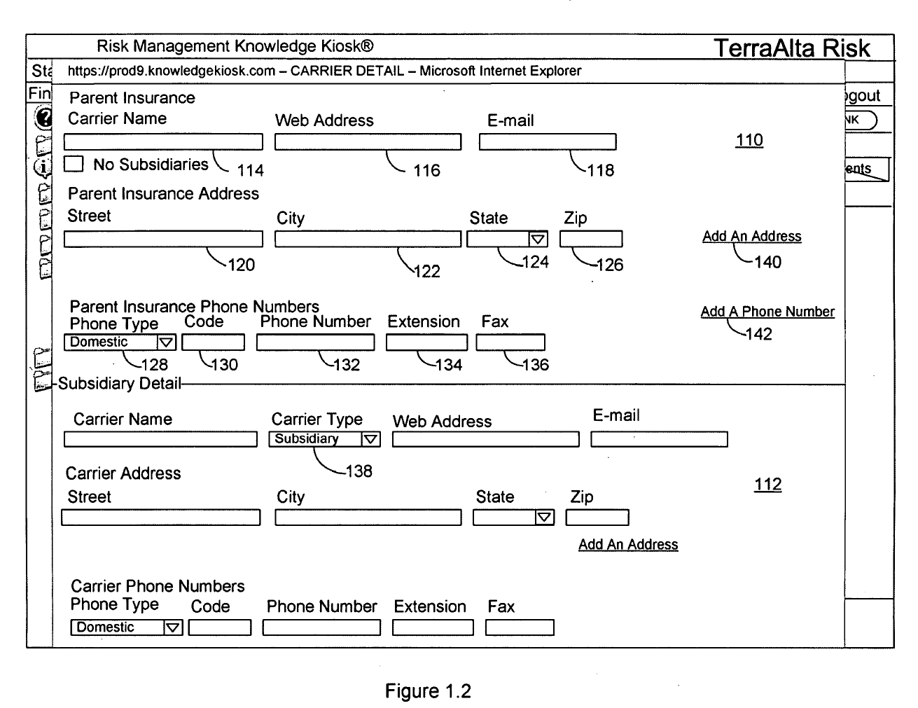

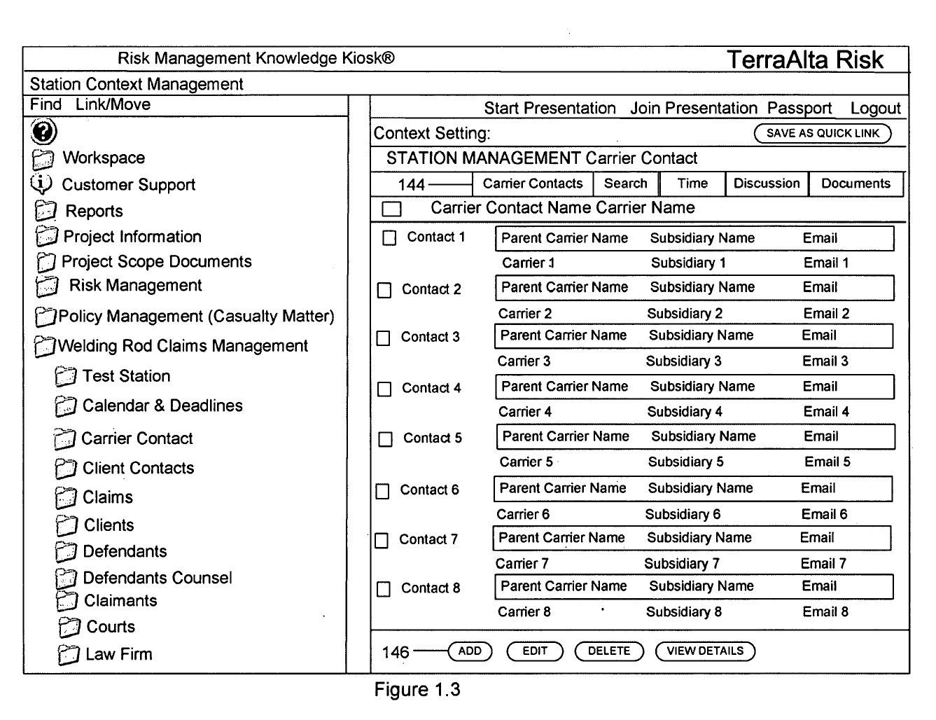

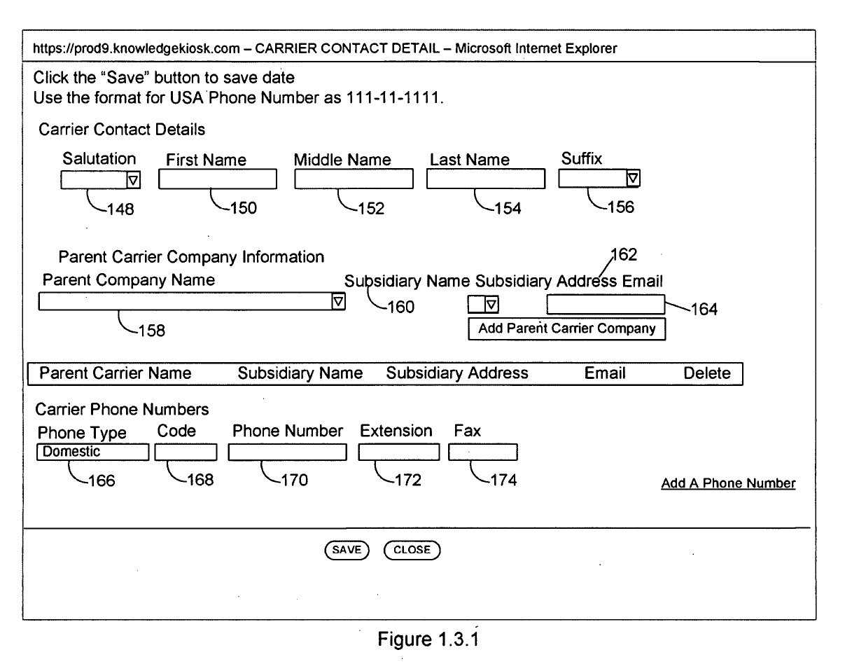

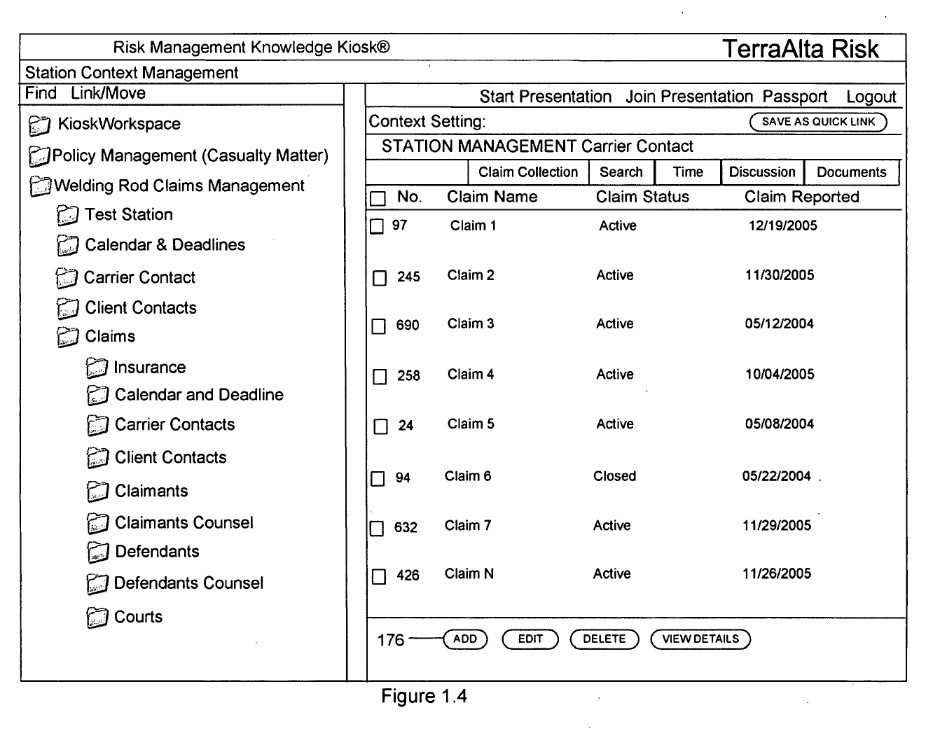

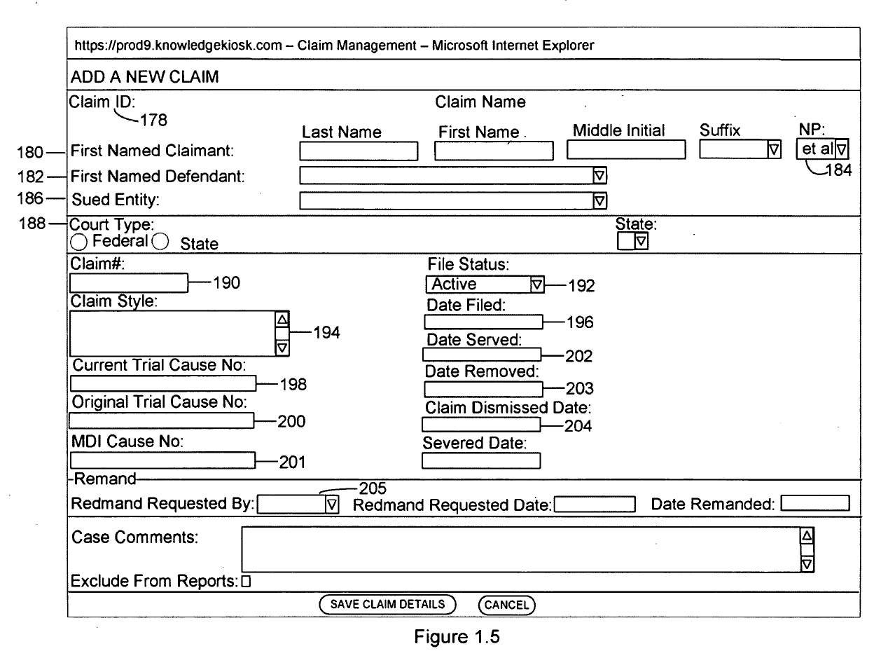

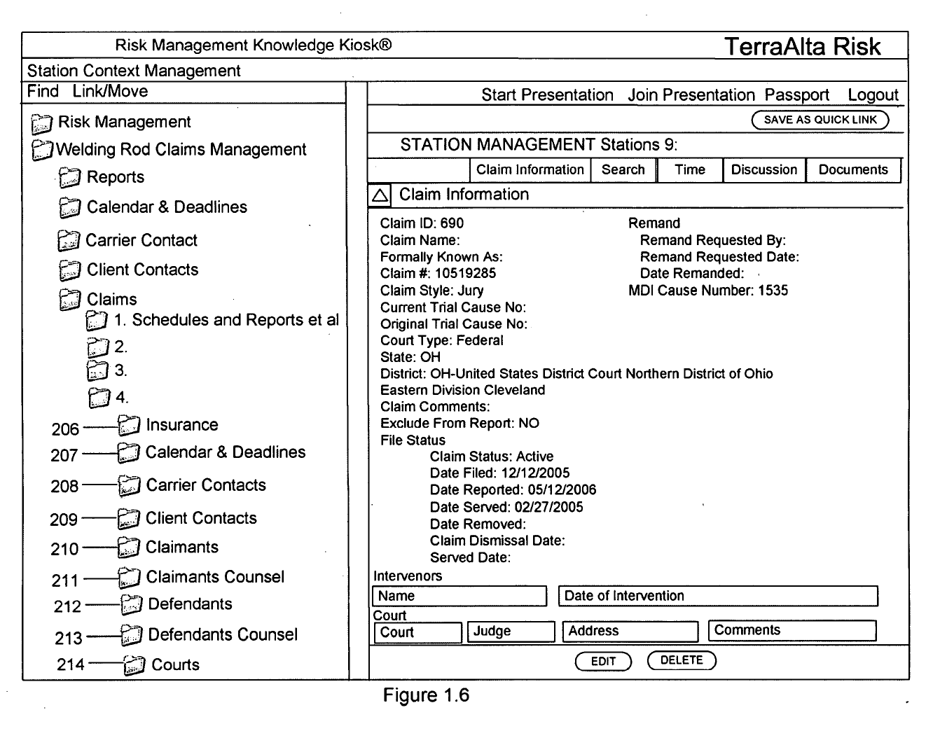

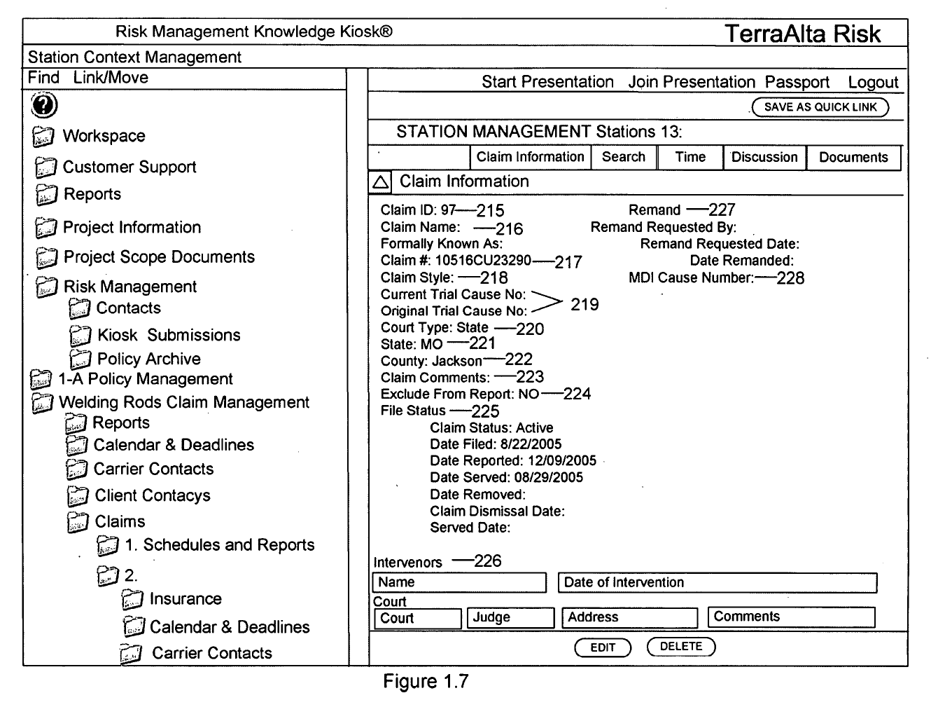

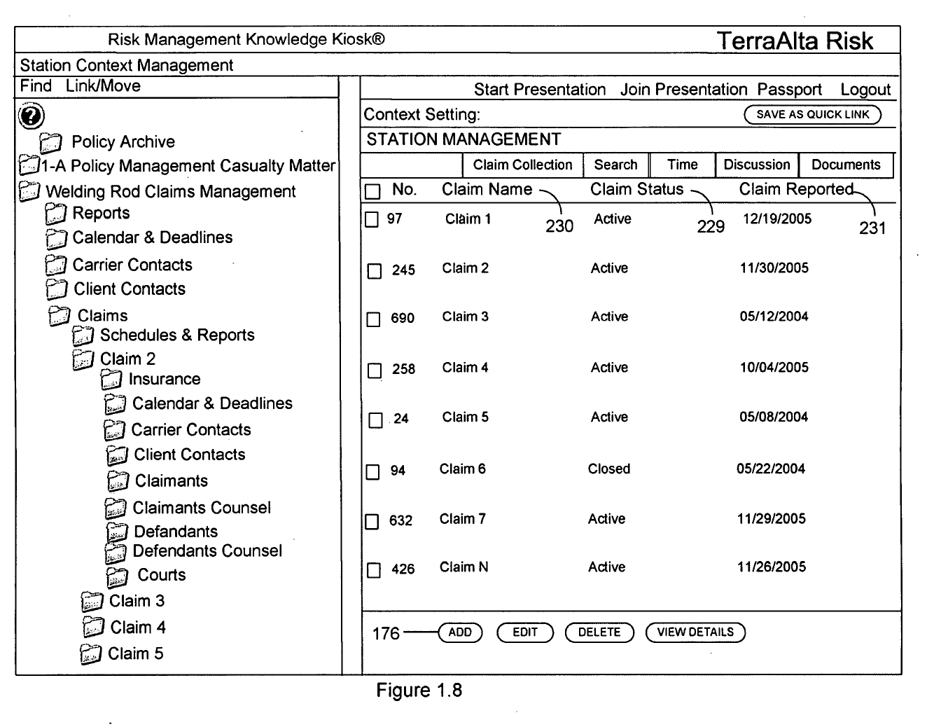

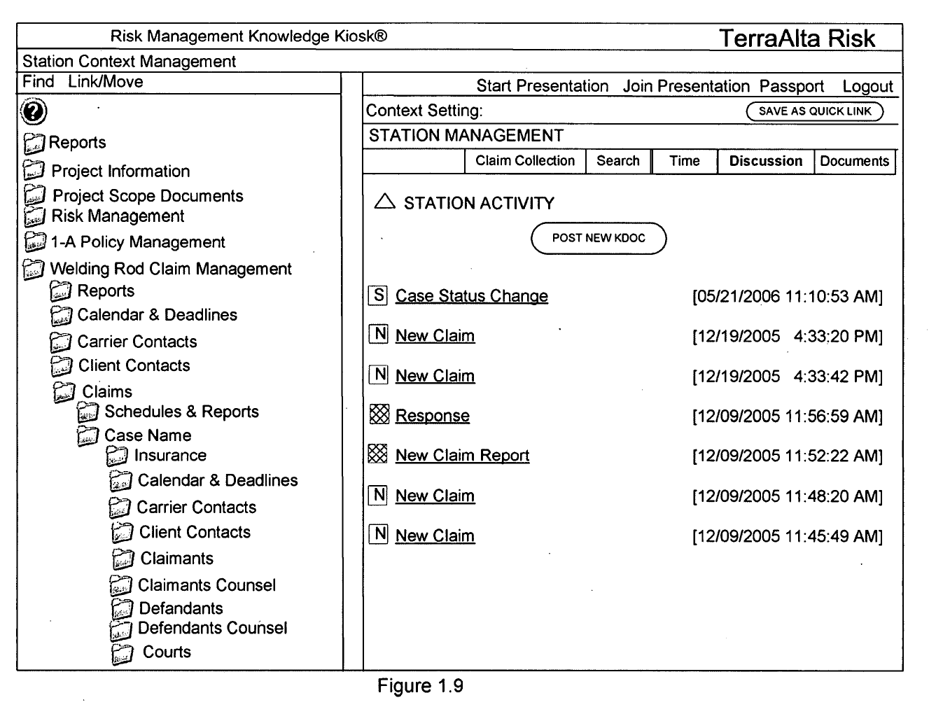

In an embodiment, a risk manager may create a MTCN station by right clicking their mouse at the top level corporate station of the Risk Management Kiosk. Here, the user may be presented with choices, which may include an “Add Station” option. When “Add Station” is selected, a pop-up box may appear. FIG. 1.1 illustrates exemplary fields that may be displayed. For example, a Name field 100 may be a free text field utilized to name the station. A Type field 102 may be a dropdown menu that may display selection options for either a standard user workstation or a specialized station, such as a notification station. In an embodiment, selection of a notification station may determine the substations and tool sets that may be provided to users. In an embodiment a Practice Area field 104 may be a dropdown menu that may include options for the types of claims (e.g., product liability) to be managed in the new notification station. In an embodiment, a Product field 106 may be a dropdown menu of specific claimant information that may appear in a claimant station. In an embodiment, selection of a Settings field 108 may integrate functionality with a policy archive system.

In an embodiment, when setting up a MTCN Station, a risk manager may add all the carriers (i.e., primary, umbrella & excess) that provided coverage to the corporation during the exposure period. Parent insurance companies often have separate subsidiary companies that specialize in managing different types of risk. As such, risk managers need to record both the parent insurance company that underwrote the insurance and the specialized subsidiary carriers that sold the policies.

In an embodiment, parent insurance carriers and their subsidiary carriers may be added. A carrier summary may include all carriers once they have been entered into the system. For example, by selecting an add button in the Carrier Summary Tab, the user may add a new carrier to the system. When a user selects the Add button, FIG. 1.2 illustrates exemplary fields that may be displayed in two separate boxes a Parent Insurance box 110 and a Subsidiary Insurance box 112. In an embodiment, if a company adds an insurance policy to the policy archives most of a client's carriers may be auto-populated in the Carrier Station for the MTCN system.

As illustrated by FIG. 1.2, fields that may be displayed may include Carrier Name 114, Carrier Type 138, Web Address 116, Email Address 118, Street 120, City 122, State 124, Zip 126, Phone Type 128, Code 130, Phone Number 132, Extension 134, Fax 136 an/or the like. Web Address 116 may represent a corporate web site address associated with the carrier. Phone Type 128 may refer to whether the carrier's telephone number is foreign or domestic. A user may also be provided with an option to add an address 140, a phone number 142 and/or a subsidiary associated with the carrier.

In an embodiment, a MTCN system may send carrier notifications to designated carrier contacts, such as claims adjusters, who individually may represent more than one insurance carrier. To add a carrier contact to the MTCN system, a user may open the MTCN Station and select the Carrier Contact Station from the first level substations as illustrated by FIG. 1.3. The Carrier Contact tab 144 may be populated with all carrier contacts previously entered. Within the Carrier Contacts tab 144, a user may select the Add 146 function from among other choices, including Edit, Delete and View Details.

FIG. 1.3.1 illustrates exemplary fields that may be displayed when a user selects the Add 146 function. As illustrated by FIG. 1.3.1 the fields may include Salutation 148, First Name 150, Middle Name 152, Last Name 154, Suffix 156, Parent Carrier Name 158, Subsidiary Name 160, Subsidiary Address 162, Email 164, Phone Type 166, Code 168, Phone Number 170, Extension 172, Fax 174 and/or the like. The user may also have the option to add a parent carrier company, an address and/or a phone number.

In an embodiment, the carrier notification process for new claims may begin when the legal department receives a legal complaint against the client. A service of process company usually serves legal complaints with a physical document; however, at the defendant's request, service of process companies may also serve legal complaints in an electronic format.

In an embodiment, once the complaint is received, the legal department may record new claim information in the Risk Management Kiosk. The user may select the top level Claims Station from the MTCN Claim Management Station. When the Claim Collection tab appears, the user may add a new claim by clicking the Add button 176 as illustrated by FIG. 1.4.

FIG. 1.5 illustrates exemplary data entry fields associated with adding a new claim. As illustrated, the fields may include a Claim ID 178, information associated with a first named claimant 180, information associated with a first named defendant 182, MIP 184, Sued Entity 186, Court Type 188, Claim Number 190, File Status 192, Claim Style 194, Date Filed 196, Current Trial Cause Number 198, Original Trial Cause Number 200, MDL Case Number 201, Date Served 202, Date Removed 203, Claim Dismissal Date 204, information regarding Remand 205 and/or the like.

In an embodiment, when a user adds a New Claim into the MTCN system, a Claim Station and its Subsidiary Stations may be automatically created. As illustrated by FIG. 1.6, Subsidiary Stations may include data fields such as Insurance Station 206, Calendar and Deadlines 207, Carrier Contacts 208, Client Contacts 209, Claimants 210, Claimant Counsel 211, Defendant 212, Defendant Counsel 213, Courts 214 and/or the like.

In an embodiment, when a new claim is created, a non-editable Claim Information cover page may be auto-created and may be displayed when a user opens the New Claim Station. In an embodiment, the page may be read-only. As illustrated by FIG. 1.7, the cover page may display the Claim Information entered for fields such as Claim ID 215, Claim Name 216, Claim # 217, Claim Style 218, Current/Original Cause # 219, Court Type 220, State 221, County 222, Claim Comments 223. Exclude from Report (y/n) 224, File Status 225, Interveners 226, Remand (status) 227. MDL Cause # 228 and/or the like.

In an embodiment, when a new claim is saved in the MTCN Claim Station, a copy may be recorded in a Claims Collection tool. The Claims Collection Tool may be available from any Claim Station. As illustrated by FIG. 1.8, this tool may provide users with a view of the current status 229 of all claims 230 related to the MTCN Claims Management Station and the date 231 each such Claim was reported to the carriers.

In an embodiment, the Claims Collection tool may aggregate claims in an alphabetized tab collection organized by the first letter of the first named claimant's last name. Users may view the entire list of claims by selecting an option located in the Claims Collection tool's alphabet display. A user may select a claim for review by checking a check box that precedes the claim number. Once the claim is selected, users may edit, delete or view its details. If a claim record is edited within the Claims Collection tool, related claims information pages may be automatically updated to reflect the edits. The ability to delete a claim may be limited to users with administration rights on the Risk Management Kiosk.

In an embodiment, when a new claim is saved to its Claim Station, a notification flag may be set within the MTCN system's notification queue which may automatically be set to schedule transmission of a claim notice to the appropriate carriers, once a related complaint is uploaded to the New Claim Station.

In an embodiment, tracking of key claimant information may be important for carrier reporting purposes and to support the legal decision making process as cases develop over time. When a new claim is saved, the system may automatically create the Claimant Station using a Station-naming convention of the first named claimant in the related complaint, Creation of the Claimant Station may auto-generate a link between claimants entered at the Claim Station level to the Claimant Collection tab, which may appear in both the Claims and Claimant Stations. The Claimant Information page may be auto-populated, This page may have button options available for users that have the ability to edit or delete the claimant.

In an embodiment, in addition to information automatically recorded on the first named claimant for each claim, users may manually add information on other claimants by selecting the Add button at the Claimant Station.

Once a Legal Department user has added a New Claim and the Claim Station has been created, the user may send an Internal Case Notice of the Claim to Risk Management and other affected departments. To send an Internal Case Notice, a user can select the Discussions Tab located in the New Claim Station as illustrated by FIG. 1.9, From the Discussion Tab, a user may select the Internal Case Notification template from the available choices in the Template dropdown. As illustrated by FIG. 2.0, when the Internal Case Notification template is selected one or more of the following actions may occur. In an embodiment, the Subject line 232 on the Notice may be pre-filled by the system. A Write Restricted field 233 may be automatically selected to ensure that the record of notice remains intact. All available users 234 may be displayed. Available users may be determined from the list of available users assigned notifications in the Station Properties for this Station. In an embodiment, a Legal Department user may select other users to notify by creating a list using icons in the graphical user interface.

In an embodiment, the MTCN system may pull data fields entered for the new claim to automatically compose an internal notice, which may be auto-populated to the notice's text box 235. A user may add any additional information, or special instructions as free text to the notice prior to transmission. In an embodiment, a user may then send the notice, which may be automatically spell-checked and transmitted to recipients in email format.

In an embodiment, from within the Discussion tool, a user may add one or more document links to an internal notice to another user. Once the notice is prepared, the user may select an Add Document(s) button and select from Available Document(s) for linking from within the Claim Station's document sets. When an email notice is received, the recipient user may be able to navigate to the linked document(s) within a Risk Management Kiosk by clicking on the document link within the email.

In an embodiment, to upload a complaint into a Claims Station, a user may first select the Sets tool inside the Claims Station where the complaint is to be stored To Access the Upload function, the user may select the appropriate Claim Set within the Sets Tab. Once the Claim Set is selected, the Set's documents and related tools are displayed as illustrated by FIG. 2.1. For example, a title 236, a document type 237, a line of coverage 238, a policy number 239 and/or the like may be displayed.

In an embodiment, a user may select an Upload tool and browse for a complaint file. FIG. 2.2 illustrates an exemplary document upload screen. In an embodiment, the user may specify the file to upload 240, and information associated with the file, such as a title 241, a source 242, document data 243, a document type 244 and/or the like. In an embodiment, if the complaint has been served to a client as a physical document, it may need to be scanned and placed into the user's network files prior to its upload to the Claims Station.

In an embodiment, the user may select a document type from the Document Types dropdown list 244 and may finish by selecting an Upload File button 245. In an embodiment, the complaint document's network file name may automatically pre-fill the Document Title box when the complaint's upload is completed.

In an embodiment, when a complaint is uploaded to its Claim Station, a notification flag, signifying the complaint's availability for carrier notification, may be set within the MTCN system's notification queue for scheduling a claim notice to the appropriate carriers.

In an embodiment, an automated Schedule Master may monitor the notification queue for open notification flags and may be run on demand, or at a predetermined time interval, such as daily, This module may perform a notification queue search for all claims that have not been previously noticed to carriers.

In an embodiment, the module may validate that all necessary notification flags are set and that claim information required to prepare the notice is present. The module may verify that related complaints have been stored in the Sets tool of the Claims Station(s) scheduled for notice. In an embodiment, when all scheduling requirements have been met, the Schedule Master may automatically execute Carrier Notifications through the Carrier Notification Program.

In an embodiment, a carrier notification program may automatically prepare and send email notices to appropriate carriers and may create a complete audit trail of claim and trial notice activity in the related Claims Station(s). In an embodiment, the carrier notification program may auto-select a template to create claim and trial notices. The program may create a consolidated template for all carrier contacts that are to be noticed. In an embodiment, the program may create one or more description links for each notification to be sent. In an embodiment, a description link may be the form “Plaintiff Last Name, Plaintiff First Name VS First Named Defendant Jurisdiction Date Served.”

In an embodiment, the program may send notifications to all carrier contacts. FIG. 2.3 illustrates an exemplary notification that may be sent according to an embodiment. In an embodiment, notifications and corresponding complaints, trial documents and the like may be posted on the system, for example on the Risk Management Satellite Kiosk as illustrated by FIG. 2.4. In an embodiment, each notice may be automatically named. For example, notices may be named according to a naming convention such as “Template Name-Date Sent-Last Name Carrier Contact-First Name Carrier Contact” as illustrated by FIG. 2.5.

In an embodiment a copy of the notification that was sent may be included in a document set associated with each claim that was included in a description link of the notice as illustrated by FIG. 2.6. In an embodiment, a record of a notice transmission may be created as illustrated by FIG. 2.7. In an embodiment, a transmittal record may be created for each claim and/or trial matter noticed. FIG. 2.8 illustrates an exemplary transmittal record according to an embodiment. As illustrated by FIG. 2.8, a transmittal record may include data fields for a carrier name 246, a representative 247 who received the notice, the date the notice was sent 248, the date the representative accessed the notice 249, a claim status 250, the date a response was received 251, the date the complaint was viewed 252, a template name 253 and/or the like. In an embodiment, the claim status 250 may include an option for a client's counter-response of appeal filed to a carrier denial. To access these entry fields a user may check the selection box and choose the edit function. In an embodiment, an option may include “Appeal Filed”, “Approved”, “Denied”, “Reservation of Rights” and/or the like.

In an embodiment, policy archive system users may set their own preferences for viewing column headers and their data fields related to documents and document sets. Users may select any or all available fields for column headers and set their choices in whatever column left-to-right column order they prefer. Column data may be further sorted in either ascending or descending order as illustrated by FIG. 2.9.

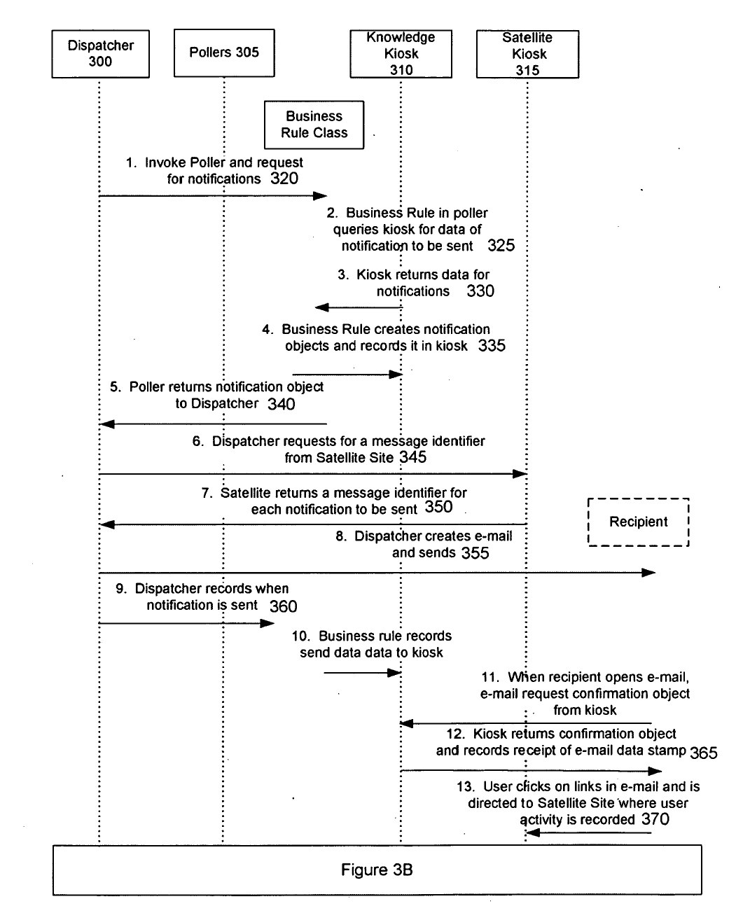

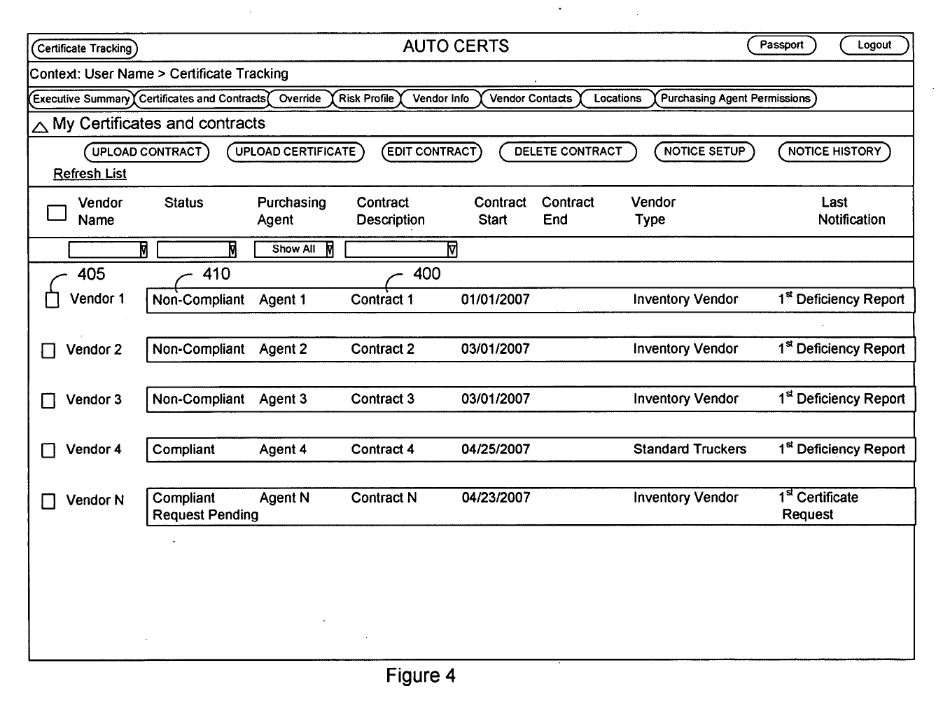

In another embodiment, a user may be notified of a deficiency, such as missing information from an application, an unfulfilled contract obligation or the like. For example, a vendor may be sent a notification if the vendor's contract compliance is not fully met. FIG. 4 illustrates exemplary notification statuses for a set of contracts. For example, as illustrated by FIG. 4, Contract 1 400 which is associated with Vendor 1 405 is non-compliant 410.

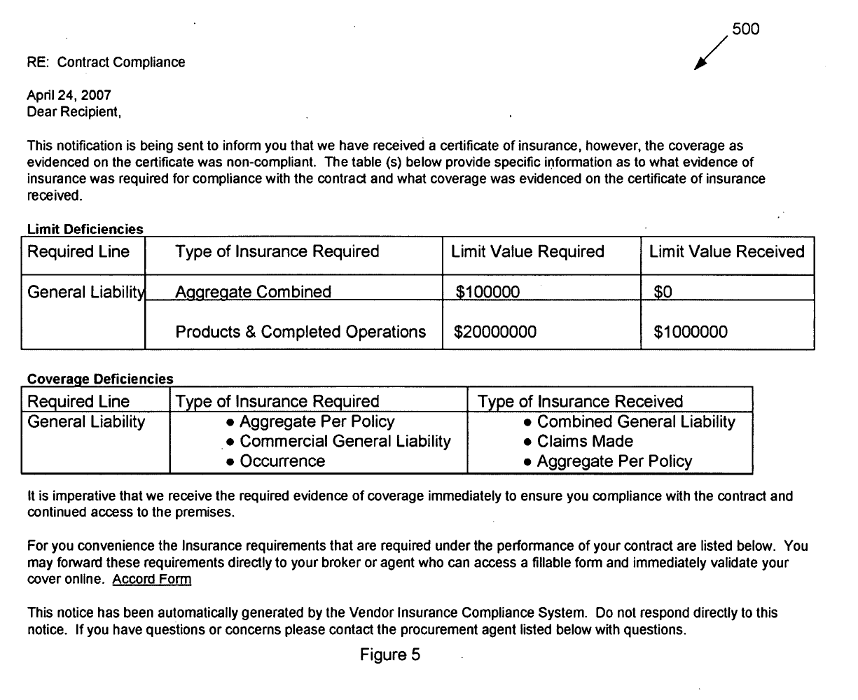

FIG. 5 depicts an exemplary notification 500 that may be sent to a recipient informing the recipient of non-compliance. FIG. 5 illustrates an example of a notification that may be sent to alert a recipient to a non-compliant certificate of insurance.

In an embodiment, the system may provide users with the ability to automatically track requests made to vendors for insurance certificates. The system may send automated notifications to select users in the event that a certificate has not been received in a specified period of time. In addition, the system may track and send notifications relating to vendor requirements, deficiencies and renewals. The system may also validate coverage compliance and create an audit trail with real time reporting of insurance certificate tracking activities.

TABLE 2

| Features and Benefits | What this means to customers |
|---|---|
| Interactive, web-based | Coordinate online with procurement, |
| compliance process | operations personnel and vendor partners |
| | throughout the entire compliance process |
| | Quickly qualify vendors' insurance |
| | requirements and, if warranted, automatically |
| | initiate a certificate of service request. |
| | Effectively manage insurance requirements for |
| | vendors contracting with multiple business |
| | locations. |
| | Validate inbound certificates on a per coverage |
| | basis. Ensure that risk transfer requirements |
| | have been met, that limits have been satisfied |
| | and that the vendor's carriers have acceptable |
| | AM Best ratings. |
| Ability to over-ride | When required, the system accommodates |
| coverage requirements | business decisions to over-ride a vendor's |
| | coverage requirements. Creates a date/time |
| | record including the name of the business |
| | manager making the over-ride decision and |
| | why. |
| Tracking vendor | Tracks vendor risk transfer process and |
| compliance | provides an audit trail of all vendor compliance |
| | documents and activities |

In an embodiment, the system may include a fully searchable and reportable library of all policies, related risk information notifications and the like.

TABLE 3

| Features and Benefits | What this means to customers |
|---|---|
| One source for | Instant, on-line access to policy library |
| policy information | |
| Policy records | Auto-creates and populates policy file |
| management | structures for consistent quality and |
| | organization of records. Extensive data |
| | recording capability enables capture of key |
| | policy information for robust reporting and |
| | analysis. “Once-and-done” data entry feature |
| | saves time, reduces cost, and eliminates |
| | duplicative work while minimizing human |
| | error |
| Tools for | Perform valuable policy coverage analysis, |
| policy analysis | utilize full text search and standard and ad hoc |
| | reporting. These tools may speed the work of |
| | evaluating current and past coverage for terms, |
| | conditions, limits layers and premiums. |
| Resource for | Coordinated with solutions for risk exposure |
| risk evaluation | and policy renewal management, so the policy |
| | archive may serve as a source of historical risk |
| | information for developing coverage |
| | specifications |

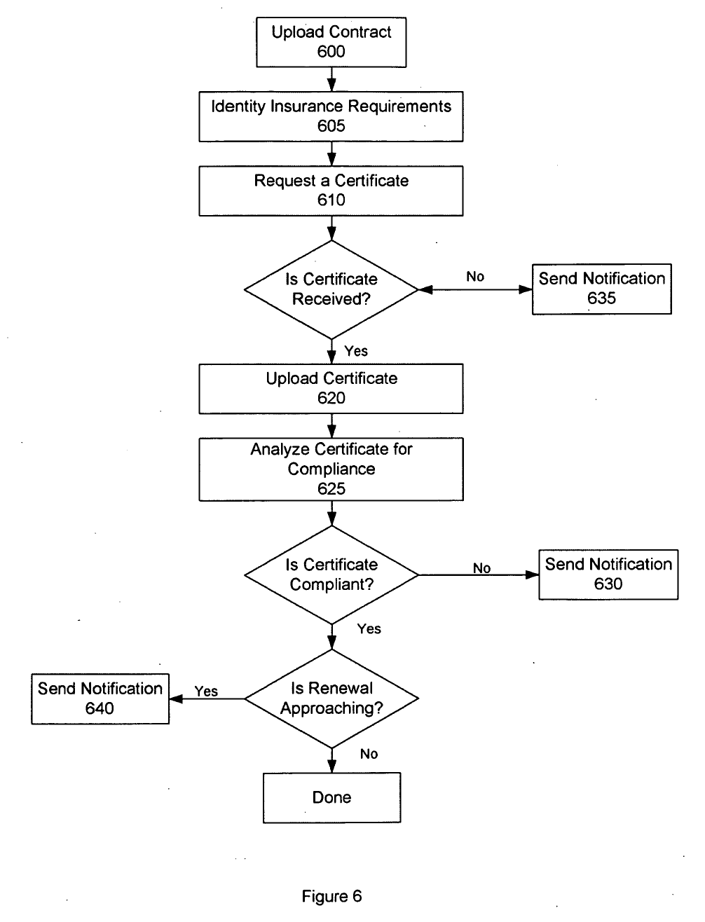

FIG. 6 depicts an exemplary flow chart of tracking vendor compliance using automated certificate tracking (ACT). When a new vendor contract is executed, the contract may be uploaded 600 to the system and insurance requirements may be identified 605. ACT may then request 610 a certificate. In an embodiment, ACT may determine 615 whether a certificate has been received. When the certificate is received. ACT may upload 620 the certificate and analyze 625 the certificate for compliance. If the certificate is non-compliant, ACT may send 630 a notification alerting the vendor to this fact. If a certificate is not received, ACT may send 635 notifications until a certificate is received. ACT may also send 640 notifications when a renewal is approaching and may generate automatic reports of vendor compliance when requested. In an embodiment, ACT may automatically generate one or more reports of vendor compliance.

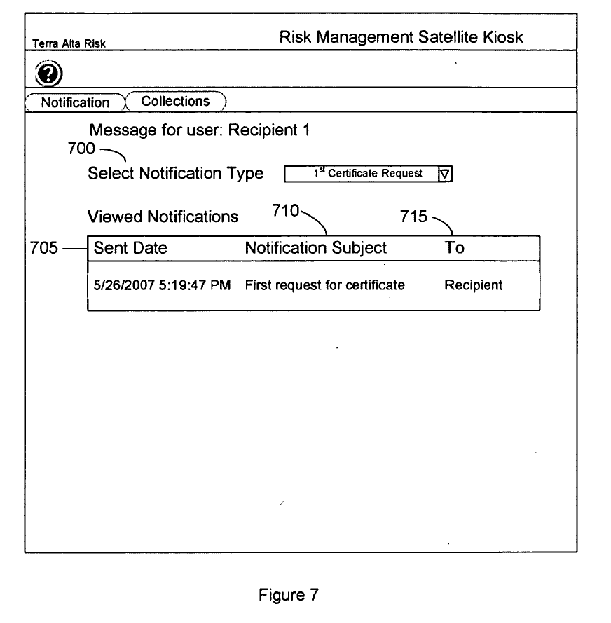

In an embodiment, a user may view all notifications that it has received. FIG. 7 depicts an exemplary interface with which the user may view its notifications. As illustrated by FIG. 7, the interface may display a notification type 700, a sent date 705, a notification subject 710, a recipient 715 and/or the like.

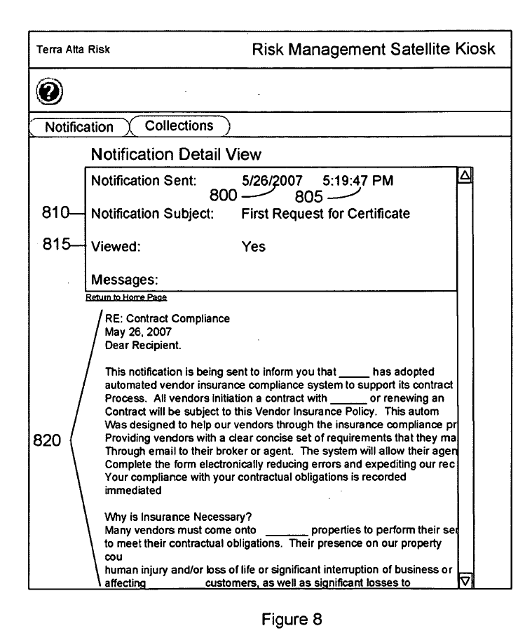

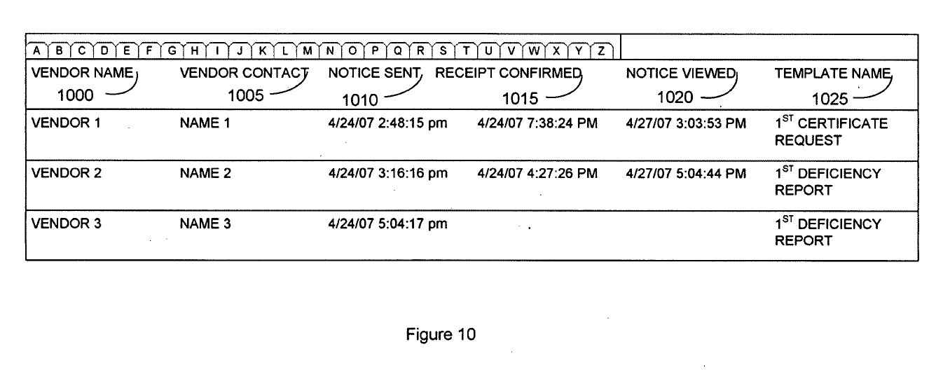

As illustrated by FIG. 8, a user may also access a previously sent notification. The user may view the date 800 and/or time 805 the notification was sent, the notification subject 810, whether the notification was viewed 815, the content 820 of the notification and/or the like. In an embodiment, a user may access a notification history. As illustrated by FIG. 10, a notification history may include a vendor name 1000, a vendor contract 1005, a date and/or time when the notification was sent 1010, a date and/or time when receipt of the notification was confirmed 1015, a date and/or time when the notice was viewed 1020, a name 1025 associated with the notification and/or the like.

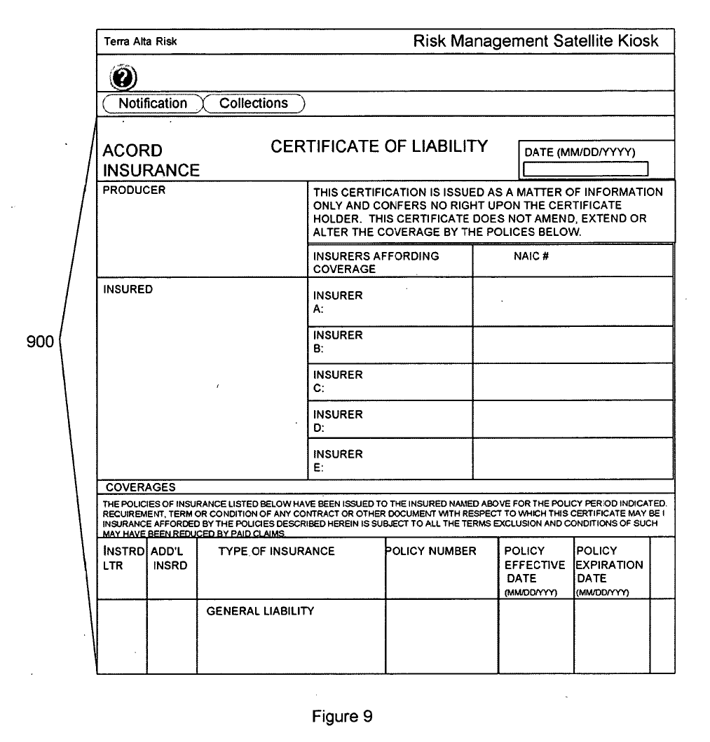

In an embodiment, a user may access a form based on the type of notice the user receives, FIG. 9 illustrates an exemplary certificate of liability 900 that a user may access from a notification.

Although the disclosed embodiments pertain to the use of a notification system in the areas of mass tort carrier litigation and insurance, the disclosed methods and systems can be applied to other areas including, but not limited to, general litigation, multi-district litigation, contract compliance, legal e-discovery, reports, computer-based testing, online education, medical rules and regulations and privacy notifications that may be required by law.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the disclosed embodiments.

What is claimed is:

1. A method of tracking electronic communications, the method comprising:
in response to receiving information associated with an insurance claim, generating a notification, wherein content of the notification is defined by one or more first business rules;
receiving an identifier associated with the received notification;
generating an electronic message comprising the notification and the identifier; and
sending the electronic message to one or more recipients, wherein the one or more recipients are defined by one or more second business rules.

2. The method of claim 1, further comprising monitoring activity of the one or more recipients relating to the content of the notification.

3. The method of claim 2, wherein monitoring activity comprises:
for each recipient, storing one or more of the following:
a time of delivery associated with the electronic message,
the content of the notification, and
a confirmation receipt, wherein the confirmation receipt is generated when the recipient accesses the electronic message.

4. The method of claim 1, wherein receiving information associated with an insurance claim comprises receiving, from a user, an insurance complaint.

5. The method of claim 1, wherein the electronic message comprises one or more navigation elements, wherein each navigation element is linked to information associated with the received notifications.

6. The method of claim 1 further comprising generating a transmittal record comprising one or more of the following:
a name of an insurance carrier associated with the insurance claim;
a name associated with a representative who received the electronic notification;
a date the electronic notification was sent;
a date the representative accessed the electronic notification;
a claim status associated with insurance claim;
a date when a response is received by the carrier; and
a date when the carrier reviews the insurance claim.

7. A method of tracking electronic communications, the method comprising:
in response to receiving information associated with a litigation matter, generating a notification, wherein content of the notification is defined by one or more first business rules;
receiving an identifier associated with the received notification;
generating an electronic message comprising the notification and the identifier; and
sending the electronic message to one or more recipients, wherein the one or more recipients are defined by one or more second business rules.

8. The method of claim 7, further comprising monitoring activity of the one or more recipients relating to the content of the notification.

9. The method of claim 8, wherein monitoring activity comprises:
for each recipient, storing one or more of the following:
a time of delivery associated with the electronic message,
the content of the notification, and
a confirmation receipt, wherein the confirmation receipt is generated when the recipient accesses the electronic message.

10. The method of claim 7, wherein receiving information associated with a litigation matter comprises receiving, from a user, one or more of a pleading, a filing and an order.

11. The method of claim 7, wherein the electronic message comprises one or more navigation elements linked to information associated with the received notifications.

12. A method of tracking vendor compliance, the method comprising:
receiving a vendor contract from a user;
receiving, from the user, information relating to one or more insurance requirements associated with the vendor contract,
automatically requesting a certificate associated with the vendor contract;
receiving the certificate,
automatically analyzing the certificate for compliance; and
displaying an indication of one of compliance and non-compliance.

13. The method of claim 12, wherein analyzing the certificate for compliance comprises determining whether information is missing from the certificate.

14. The method of claim 12, wherein analyzing the certificate for compliance comprises determining whether the certificate includes information that is inaccurate.

15. The method of claim 12, further comprising:
generating and sending an electronic message to a vendor associated with the vendor contract.

16. The method of claim 12, further comprising:
generating and sending one or more notifications to a vendor associated with the vendor contract, wherein the one or more notifications are configured to alert the vendor of an upcoming renewal associated with the vendor contract.

17. A method of tracking vendor compliance, the method comprising:
receiving a vendor contract from a user;
receiving, from the user, information relating to one or more insurance requirements associated with the vendor contract;
automatically requesting a certificate associated with the vendor contract,
determining whether the requested certificate has been received; and
sending a notification to a vendor associated with the vendor contract.

18. The method of claim 17, further comprising:
repeating the determining and the sending until the requested certificate is received.

19. The method of claim 17, further comprising determining whether information is missing from the received certificate.

20. The method of claim 17, further comprising determining whether the received certificate includes information that is inaccurate.

21. The method of claim 17, further comprising:
determining whether the received certificate is non-compliant; and
generating and sending an electronic message to a vendor associated with the vendor contract.

22. The method of claim 17, further comprising:
generating one or more renewal notifications; and
sending the one or more renewal notifications to a vendor associated with the vendor contract, wherein the one or more renewal notifications are configured to alert the vendor of an upcoming renewal associated with the vendor contract.
